(19) United States
(12) Patent Application Publication
(10) Pub. No.: US 2025/0265774 A1
(43) Pub. Date: Aug. 21, 2025

(54) SCENE RECORDING AND RECONSTRUCTING DEVICE AND SCENE RECORDING AND RECONSTRUCTING METHOD IN VIRTUAL SPACE

(71) Applicant: Hitachi, Ltd., Tokyo (JP)

(72) Inventors: Shintaro SUZUKI, Tokyo (JP); Akihiko HYODO, Tokyo (JP)

(21) Appl. No.: 18/857,561

(22) PCT Filed: Mar. 13, 2023
(86) PCT No.: PCT/JP2023/009609

§ 371 Date: Oct. 17, 2024

(30) Foreign Application Priority Data
Jun. 3, 2022 (JP) 2022-091231

(51) Int. Cl. G06T 17/00

(52) U.S. Cl. CPC G06T 17/00

(57) ABSTRACT

In order to attain the above object, a scene recording and reconstructing device that records and reconstructs scenes in a virtual space, includes a geometry recording unit that records geometry information which describes a shape or an appearance of an object constituting a scene, a record recording unit that records record information which is time-series information on an event performed by an object, a knowledge graph recording unit that records a context of a scene as a knowledge graph, and a scene reconstruction unit that reconstructs a desired scene in a virtual space by identifying a reconstruction target scene from a context of a scene recorded in the knowledge graph recording unit, acquiring geometry information and record information required to reconstruct the desired scene, and re-combining the geometry information and the record information.

### TECHNICAL FIELD

The present invention relates to a scene recording and reconstructing device and a scene recording and reconstructing method in a virtual space.

### BACKGROUND ART

Virtual reality (VR), which is a technology of presenting a virtual space formed of virtual objects created by CG (Computer Graphics), has come into widespread use in games, sports, remote medical treatments, maintenance works, etc. For example, virtual reality has been used for trainings and simulations of various works and AI learning in virtual spaces.

For example, in a case where a past scene is recreated in a virtual space to implement interactive training or AI agent training and to conduct a simulation thereof, there has been a problem that it is seriously difficult to search for and pick up a scene having a desired feature from an enormous number of past scenes. The reason is because, on a common ground where an environment the same as the real one is digitally recreated, events in a real space are constantly recreated and recorded in a virtual space, so that the number of recorded past scenes is enormous. In addition, to identify when and where a specific scene has occurred, it is necessary to check all of the recorded scenes.

Further, as in AI agent training, in a case of multiple virtual scenes being simultaneously operated multiple times, recreation of a scene having a minimum and proper time range in a minimum and proper space is required.

Patent Literature 1 is a prior art literature in the present technical field. Patent Literature 1 discloses a game apparatus in which a game image obtained as a result of advancement of a game is displayed in a replayed manner in response to a replay display request from a player. The game apparatus is configured to perspectively transform a virtual 3D space from a virtual camera onto a virtual screen on the basis of a character status, pad information inputted by the player, an initial value used to generate a random number in the process of advancing the game, and virtual camera control information, and display the generated 2D image in a replayed manner on a display device.

### CITATION LIST

### Patent Literature

Patent Literature 1: JP-2010-142305-A

### SUMMARY OF THE INVENTION

### Problem to be Solved by the Invention

In Patent Literature 1, information necessary to recreate a game scene is completely recorded, and the scene is reconstructed in a virtual space on the basis of the recorded information. Thus, reconstruction of an optionally determined time range can be implemented. However, semantic fragmentation of scene constituting elements is not performed, and thus, although a specific cut can be extracted by designation of a time, a cut cannot be extracted or elements to be reconstructed cannot be selected on the basis of semantic information such as an event or an action. Accordingly, a problem has been presented that it is impossible to meet a requirement for recreation of a scene having a minimum and proper time range in a minimum and proper space.

In view of the above problems, an object of the present invention is to provide a scene recording and reconstructing device and a scene recording and reconstructing method by which extraction and reconstruction of a desired scene based on semantic information can be easily implemented, and proper extraction of a scene can be implemented considering interactions between objects.

### Means for Solving the Problem

One aspect of the present invention is a scene recording and reconstructing device that records and reconstructs scenes in a virtual space. The scene recording and reconstructing device includes: a geometry recording unit that records geometry information which describes a shape or an appearance of an object constituting a scene; a record recording unit that records record information which is time-series information on an event performed by an object; a knowledge graph recording unit that records a context of a scene as a knowledge graph; and a scene reconstruction unit that reconstructs a desired scene in a virtual space, as required, by identifying a reconstruction target scene from a context of a scene recorded in the knowledge graph recording unit, acquiring geometry information and record information required to reconstruct the desired scene respectively from the geometry recording unit and the record recording unit, and re-combining the geometry information and the record information.

### Advantages of the Invention

The present invention can provide a scene recording and reconstructing device and a scene recording and reconstructing method by which extraction and reconstruction of a desired scene can be easily implemented and proper extraction of a scene can be implemented.

### BRIEF DESCRIPTION OF THE DRAWINGS

FIG. 1 is a configuration block diagram of a scene recording and reconstructing system according to an embodiment.

FIG. 2 is a schematic diagram of a knowledge graph stored in a knowledge graph recording unit according to the embodiment.

FIG. 3 indicates property information stored in each node in a space layer in a knowledge graph according to the embodiment.

FIG. 4 indicates property information stored in an agent node describing a dynamic object in an agent/object layer in a knowledge graph according to the embodiment.

FIG. 5 indicates property information stored in an agent node describing a static object in an agent/object layer in a knowledge graph according to the embodiment.

FIG. 6 indicates property information stored in a stay node in a stay event layer in a knowledge graph according to the embodiment.

FIG. 7 indicates property information stored in a node in an activity layer in a knowledge graph according to the embodiment.

FIG. 8 is a process flowchart in a scene registration unit according to the embodiment.

FIG. 9 is a detailed flowchart of record addition processing for an existing element in FIG. 8.

FIG. 10 is a detailed flowchart of record generation processing for a new element in FIG. 8.

FIG. 11 is a process flowchart in a scene reconstruction unit according to the embodiment.

FIG. 12 is a detailed flowchart of automatic scene expansion processing in FIG. 11.

FIG. 13 is a detailed flowchart of interactive scene expansion processing in FIG. 11.

FIG. 14 indicates an example of display on a user interface unit in the scene interactive expansion processing in FIG. 13.

FIG. 15 indicates an example of display of the user interface unit updated after selection of a candidate graph element in FIG. 14.

### MODES FOR CARRYING OUT THE INVENTION

Hereinafter, an embodiment of the present invention will be explained with reference to the drawings. It is to be noted that the following embodiment will be explained on assumption that the present invention is applied to a virtual training system for firefighting/rescue operations.

### First Embodiment

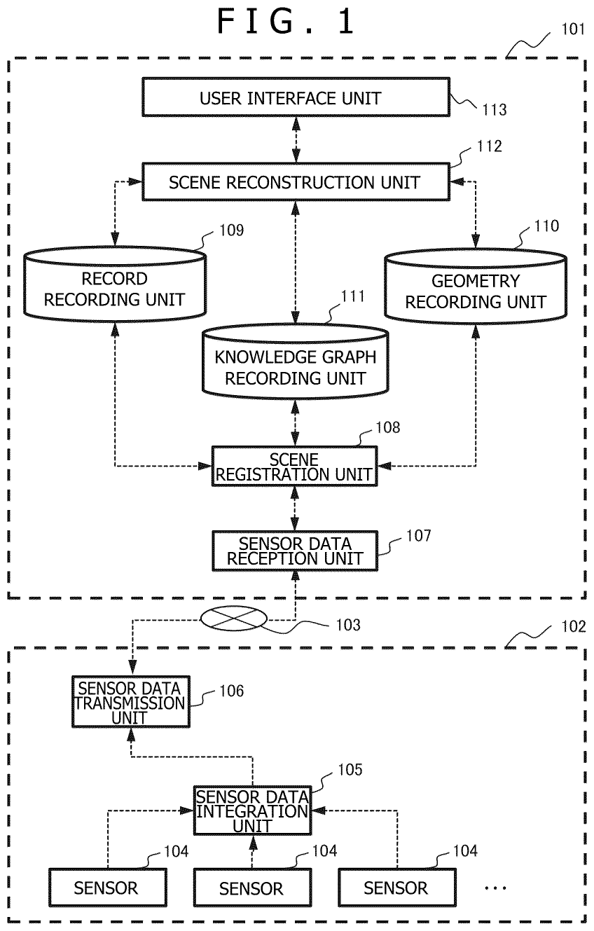

FIG. 1 is a configuration block diagram of a scene recording and reconstructing system according to the present embodiment. In FIG. 1, the scene recording and reconstructing system is formed of a scene recording and reconstructing device 101 and a real space sensing device 102 that are connected to each other over a network 103.

In the real space sensing device 102, a plurality of sensors 104 measure a scene in a real space, that is, measure a position and an action of a person or an object, a sensor data integration unit 105 integrates information from the sensors, and the measurement data is transmitted to the scene recording and reconstructing device 101 via a sensor data transmission unit 106.

In the scene recording and reconstructing device 101, a sensor data reception unit 107 receives measurement data from the real space sensing device 102, and a scene registration unit 108 separates a scene into record information (which describes time-series information on an event or an action), geometry information (which describes a shape or an appearance), and a knowledge graph (which describes a context representing the relationship or the like between the seen and before and after the scene, and a geometry-record association), and stores these information in a record recording unit 109, a geometry recording unit 110, and a knowledge graph recording unit 111, respectively.

The scene reconstruction unit 112 receives a request from a user interface unit 113, searches for, extracts, and identifies a scene to be reconstructed, from the context of scenes recorded in the knowledge graph recording unit 111, and reconstructs a scene in a 3D virtual space by acquiring record information and geometry information required to reconstruct the scene respectively from the record recording unit 109 and the geometry recording unit 110, and re-combining the record information and the geometry information, and then, provides the rendering result or space information to the user interface unit 113.

It is to be noted that the scene recording and reconstructing device 101 is formed of, in terms of hardware, a CPU of a typical information processing device and a storage unit, and is implemented by software processing in the CPU interpreting and executing operation programs for implementing respective functions. In addition, accumulation units such as the record recording unit 109, the geometry recording unit 110, and the knowledge graph recording unit 111 may be set on a cloud.

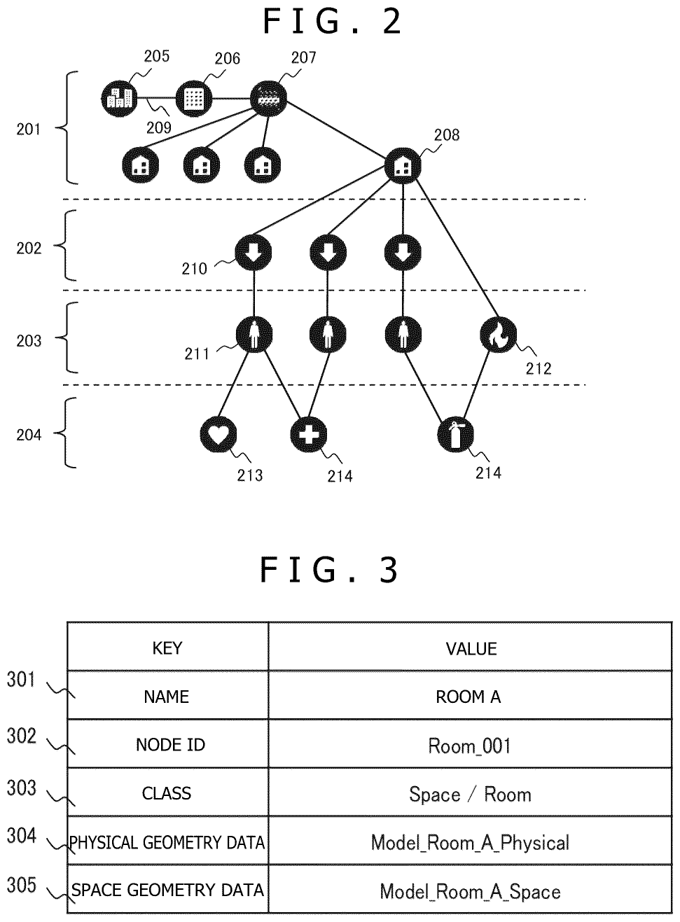

FIG. 2 is a schematic diagram of a knowledge graph stored in the knowledge graph recording unit 111 according to the present embodiment. Nodes each corresponding either to geometry information or to individual record information, and links which describe relationships among these information, constitute the knowledge graph. FIG. 2 depicts a scene of firefighting and rescue efforts in a disaster, by way of example.

In FIG. 2, the knowledge graph includes a space layer 201, a stay event layer 202, an agent/object layer 203, and an activity layer 204.

The space layer 201 includes nodes (hereinafter, also referred to as elements) such as a district node 205, a building node 206, a floor node 207, and a room node 208, and corresponds to geometry information (a shape or an appearance). The nodes are linked by relations 209 which are links indicating inclusion relations and positional relations.

The stay event layer 202 and the agent/object layer 203 include a stay node 210, an agent node 211 which describes a person, a robot, or the like, and an object node 212 which describes an object. The nodes in the agent/object layer 203 and the nodes in the space layer 201 are linked directly via the relations 209, or linked via the stay nodes 210, whereby the locations of the nodes in the agent/object layer 203 are indicated. It is to be noted that the stay node 210 corresponds to record information (which describes time-series information on an event or an action). Further, the agent node 211 and the object node 212 correspond to geometry information (a shape or an appearance).

The activity layer 204 describes action information of the nodes in the agent/object layer 203. An action node 213 of an action such as walking or making a gesture performed by an agent alone is expressed by being linked, via the relation 209, to the agent node 211 having performed the action. An action node 214 of an action such as rescuing or firefighting which involves a doer and an objective person/object is expressed by being linked to a node of the doer and a node of the objective person/object via respective relations 209. It is to be noted that the action nodes 213 and 214 correspond to record information (which describes time-series information on an event or an action).

FIG. 3 is a table indicating property information stored in each node in the space layer 201 in a knowledge graph according to the present embodiment. In FIG. 3, each node in the space layer 201 stores name 301, node ID 302 for uniquely identifying the node, class 303 indicating a category of the node, physical geometry data 304 indicating a name or a file path of physical geometry information indicating a physical shape/appearance of the node, and space geometry data 305 indicating a name or a file path of space geometry information describing a spatial area occupied by the node.

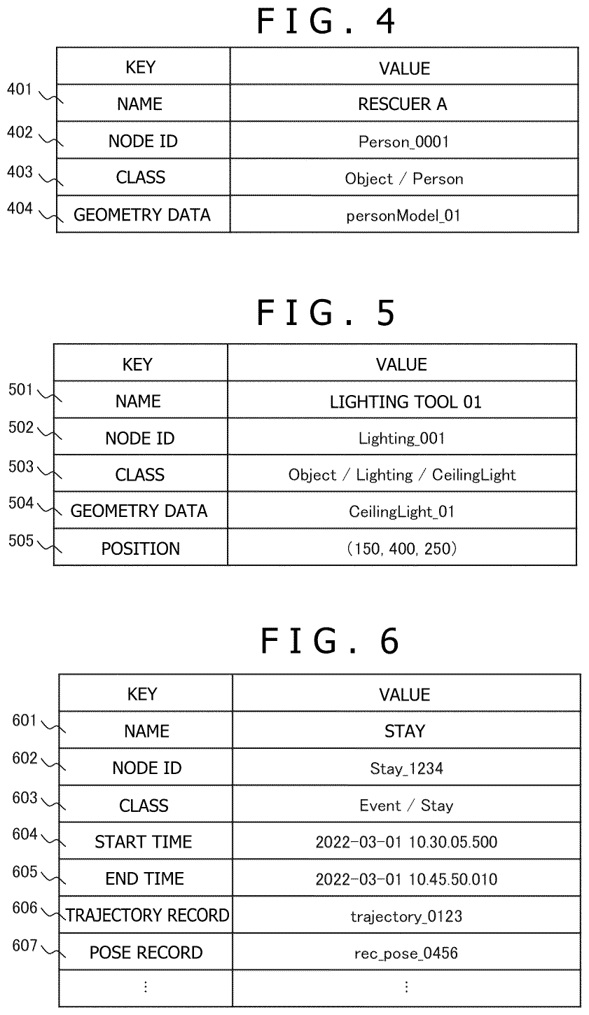

FIG. 4 is a table indicating property information stored in the agent node 211 which describes a dynamic object in the agent/object layer 203 in the knowledge graph according to the present embodiment. In FIG. 4, the dynamic object refers to an object, e.g., an unfixed piece of furniture, the position of which can be changed. The node of the dynamic object is linked to a node in the space layer 201 via the stay node 210, whereby the location of the dynamic object is indicated. In FIG. 4, the node of the dynamic object stores name 401, node ID 402 for uniquely identifying the node, class 403 indicating the category of the node, and geometry data 404 indicating a name or a file path of geometry information describing a physical shape/appearance of the dynamic object.

FIG. 5 is a table indicating property information stored in the object node 212 which describes a static object in the agent/object layer 203 in the knowledge graph according to the present embodiment. In FIG. 5, the static object refers to an object, e.g., a fixture, a wall, or a floor, the position of which is unchanged. The node of the static object is directly linked to a node in the space layer 201 via the relation 209, whereby the location of the static object is indicated. In FIG. 5, the node of the static object stores name 501, node ID 502 for uniquely identifying the node, class 503 indicating the category of the node, geometry data 504 indicating a name or a file path of geometry information describing a physical shape/appearance of the static object, and position 505 indicating detailed position coordinates of the static object.

FIG. 6 is a table indicating property information stored in the stay node 210 in the stay event layer 202 in the knowledge graph according to the present embodiment. In FIG. 6, the stay node 210 stores name 601, node ID 602 for uniquely identifying the node, class 603 indicating the category of the node, start time 604 and end time 605 of the stay, trajectory record 606 indicating a name or a file path of record information describing a trajectory during the stay, and pose record 607 indicating a name or a file path of record information describing an action/gesture during the stay.

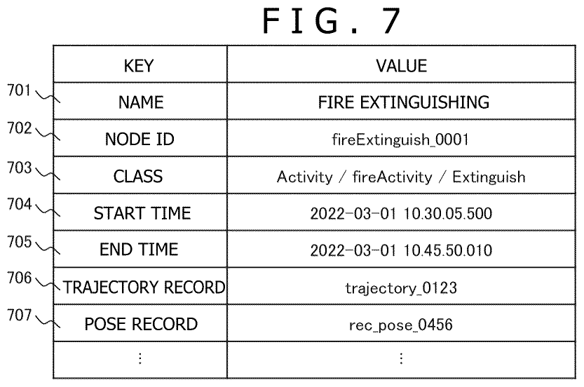

FIG. 7 is a table indicating property information stored in a node in the activity layer 204 in the knowledge graph according to the present embodiment. In FIG. 7, the node in the activity layer 204 stores name 701, node ID 702 for uniquely identifying the node, class 703 indicating the category of the node, start time 704 and end time 705 of the activity, trajectory record 706 indicating a name or a file path of record information describing a trajectory during the activity, and pose record 707 indicating a name or a file path of record information describing an action/gesture during the activity.

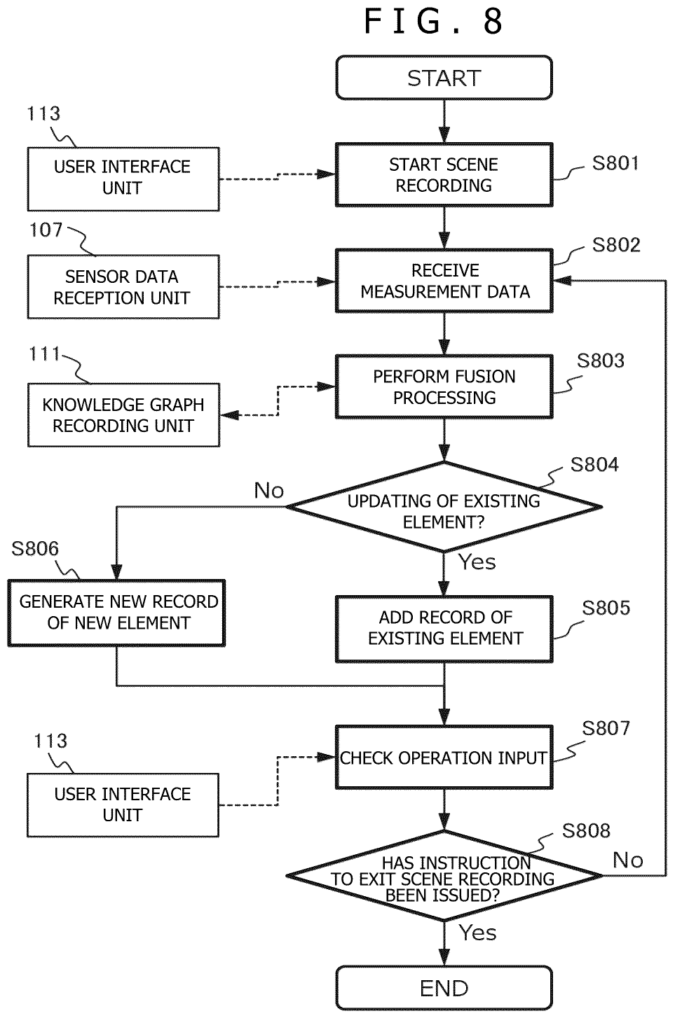

FIG. 8 is a process flowchart in the scene registration unit 108 according to the present embodiment. In FIG. 8, upon receiving a recording start instruction from the user interface unit 113, the scene registration unit 108 starts scene recording (S801).

After the scene recording is started, when measurement data is received at the sensor data reception unit 107 (S802), fusion processing of comparing and combining the measurement data with elements recorded in the knowledge graph recording unit 111 is performed (S803), and then, whether the measurement data indicates an update of an existing scene element or an unknown scene element is determined (S804). When the measurement data indicates an update of an existing element, a record of the element is added (S805). When the measurement data is information about an unknown element, the element is added to the knowledge graph, and a new record is generated (S806).

Thereafter, an operation input from the user interface unit 113 is checked (S807), and whether an instruction to exit the scene recording has been issued is determined (S808). When the command has been issued, the scene recording is exited. When such a command has not been issued, the flow returns to S802 to continue the scene recording.

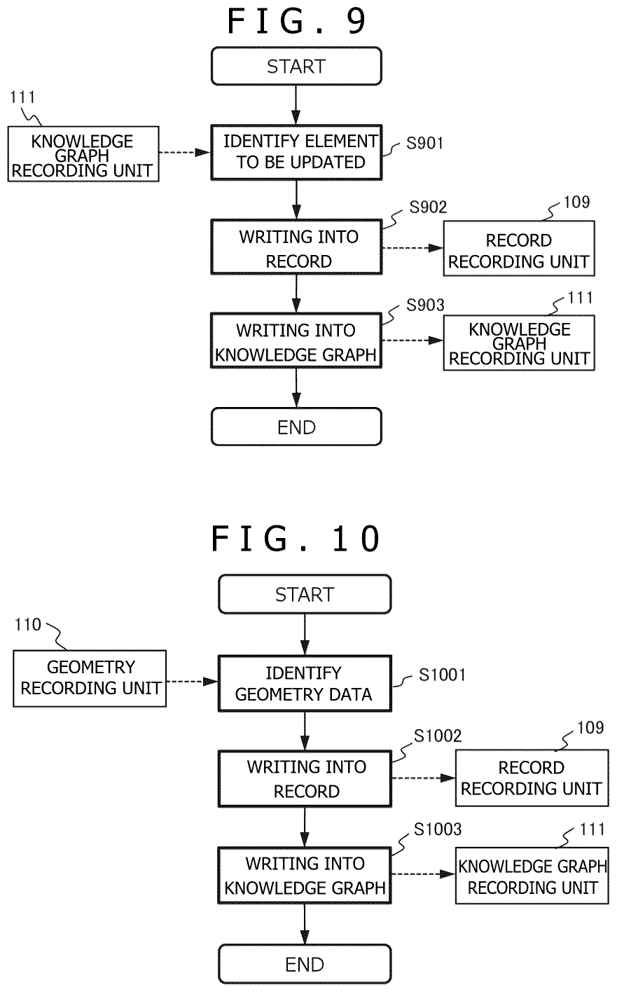

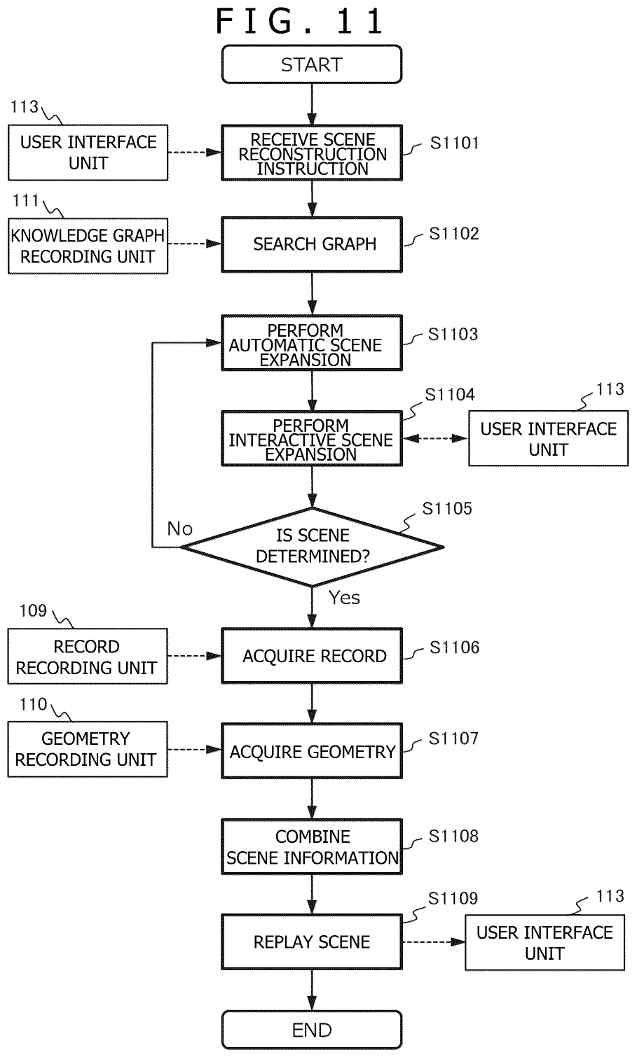

FIG. 9 is a detailed flowchart of the record addition processing for an existing element in step S805 in FIG. 8. In FIG. 9, first, access to the knowledge graph recording unit 111 is made to identify an element to be updated (S901). Next, an update of the record information about the element is written into the record recording unit 109 (S902). Subsequently, an update of scene context information in which geometry information is linked to the record information is written into the knowledge graph recording unit 111 (S903).

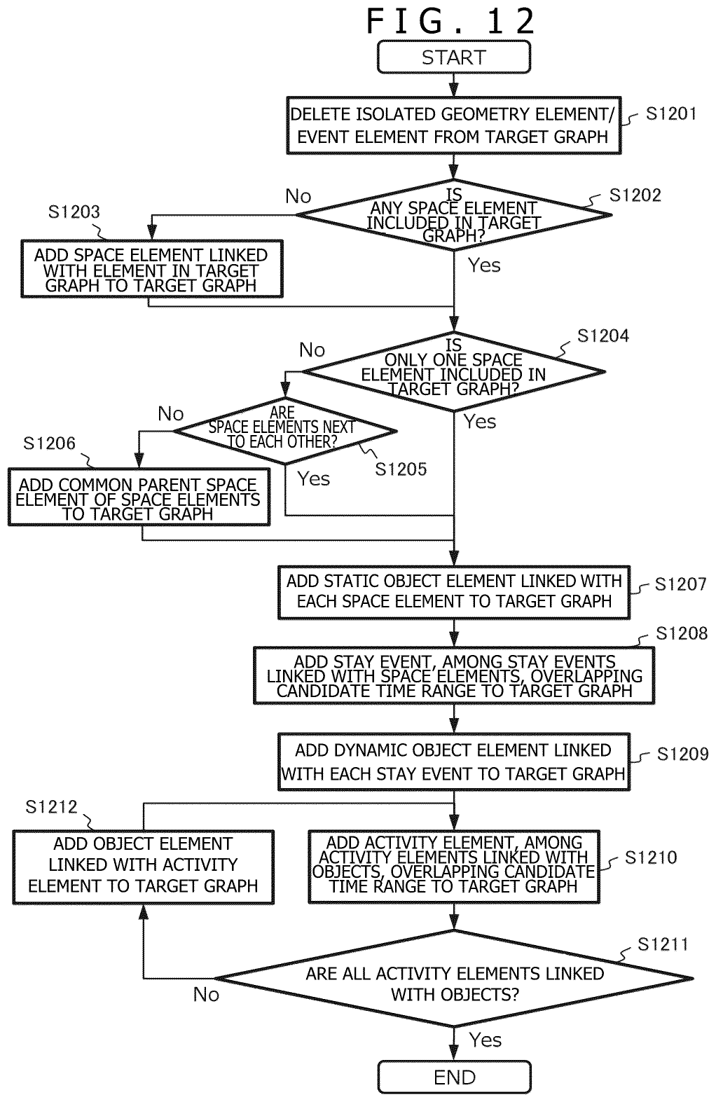

FIG. 10 is a detailed flowchart of the record generation processing for a new element in step S806 in FIG. 8. In FIG. 10, first, access to the geometry recording unit 110 is made to identify geometry data corresponding to a doer and an objective person/object of a new record to be added (S1001). Next, record information such as a trajectory or a gesture is written into the record recording unit 109 (S1002). Subsequently, scene context information in which the geometry information and the record information are linked to each other is written into the knowledge graph recording unit 111 (S1003).

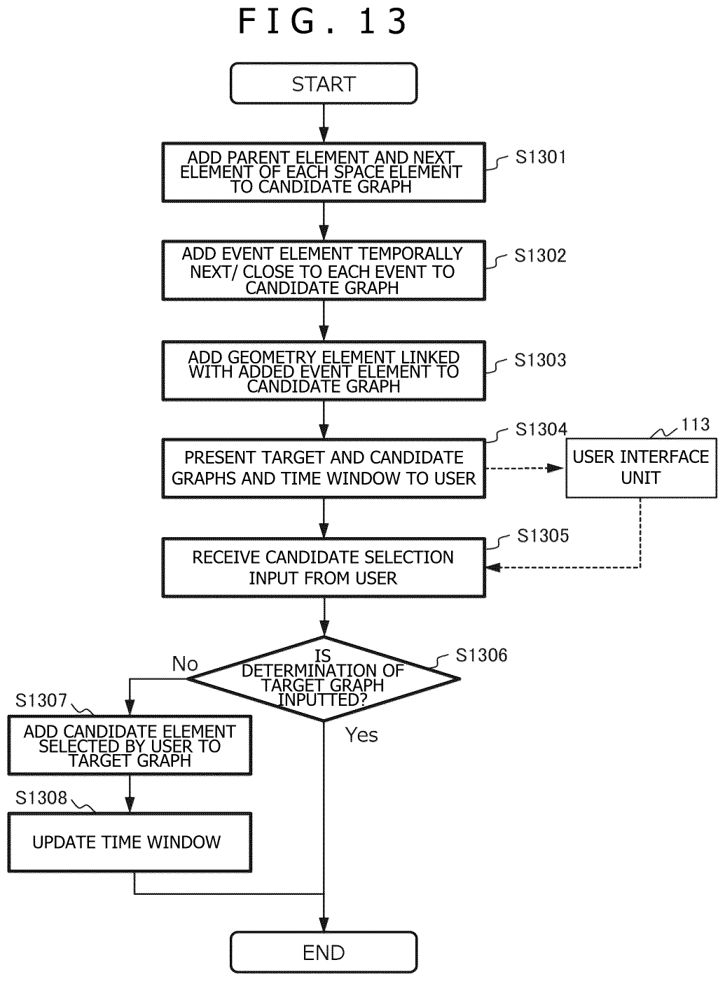

FIG. 11 is a process flowchart in the scene reconstruction unit 112 according to the present embodiment. In FIG. 11, upon receiving a reconstruction start instruction from the user interface unit 113, the scene reconstruction unit 112 starts scene reconstruction (S1101).

In the processing S1101, a query graph describing a feature in a scene to be searched for is received. In the processing S1102, access to the knowledge graph recording unit 111 is made to identify a partial graph that matches the query graph from stored scene context information (S1102).

Then, the partial graph is expanded so as to comprehensively include events having the same space and the same time, and automatic scene expansion of adjusting space and time ranges, which are the target of the scene reconstruction, is performed (S1103), and the expanded partial graph is presented to the user interface unit 113, and interactive scene expansion is performed (S1104). Subsequently, whether a reconstruction target scene is determined is determined (S1105). If a reconstruction target scene is not yet determined, the flow returns to the processing S1103 to repeat the automatic expansion and the interactive expansion.

If a scene is determined, record information included in the scene is acquired from the record recording unit 109 (S1106), and geometry information included in the scene is acquired from the geometry recording unit 110 (S1107). The record information and the geometry information are combined on the basis of the context information stored in the partial graph (S1108).

Then, the scene is replayed in a virtual space on the basis of the combined scene information, and a rendering result of the replayed scene or space information and a processing result in the virtual space are presented to the user interface unit 113 (S1109).

FIG. 12 is a detailed flowchart of the automatic scene expansion processing S1103 in FIG. 11. In FIG. 12, first, in a case where an isolated geometry element or event element is included in a partial graph (target graph) indicating a current scene reconstruction target, the independent element is deleted from the target graph (S1201).

Next, whether one or more of the nodes in the space layer 201 are included in the target graph is determined (S1202). If none of the nodes is included, a space element that is linked to an element in the target graph is identified, and is added to the target graph (S1203).

Next, whether only one space element is included in the target graph is determined (S1204). When a plurality of space elements are included, whether the space elements are next to each other is further determined (S1205). If No at both of S1204 and S1205, a space element which is a common parent of the space elements included in the target graph is identified on the knowledge graph, and is added to the target graph (S1206).

Next, a static object element linked to each space element in the target graph is added to the target graph (S1207), and a stay event, of stay events linked to the respective space elements, overlapping a candidate time range of the target graph is added to the target graph (S1208). Further, a dynamic object element linked to each stay event is added to the target graph (S1209).

Next, among activity elements linked to respective agent/object elements in the target graph, an activity element overlapping the candidate time range is identified on the knowledge graph, and is added to the target graph (S1210).

Then, whether all of the activity elements on the target graph are linked to agents/objects corresponding to doers and objective persons/objects is determined (S1211). If not so, an agent/object element that is linked to the non-liked activity element is identified on the knowledge graph, and is added to the target graph (S1212). Then, the flow returns to S1210.

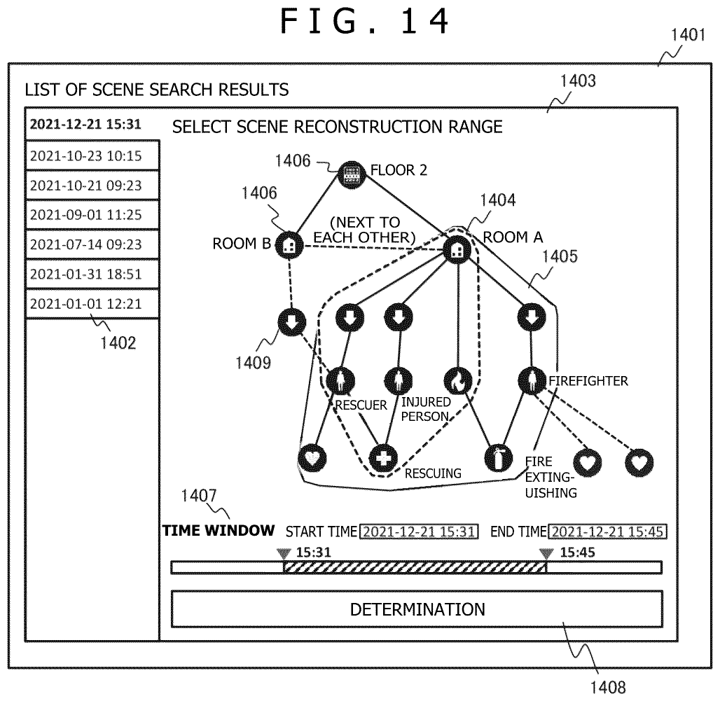

FIG. 13 is a detailed flowchart of the interactive scene expansion processing S1104 in FIG. 11. In FIG. 13, first, regarding a space element included in a partial graph (target graph) indicating a current scene reconstruction target, a parent space element thereof and a space element spatially next thereto are identified on the knowledge graph, and these identified space elements are added to a graph (candidate graph) that indicates candidate elements of a scene reconstruction target (S1301).

Next, event elements that are temporally next/close to an event (stay/activity) element included in the target graph are identified on the knowledge graph, and are added to the candidate graph (S1302). Furthermore, geometry elements (space elements, agent/object elements) that are linked to the added event elements are identified on the knowledge graph, and are added to the candidate graph (S1303).

Subsequently, a time range (candidate time range) covered by the event elements on the current target graph is calculated, and the target graph, the candidate graph, and the candidate time range are presented to the user interface unit 113 (S1304), and a user's candidate selection input is received (S1305).

Then, the content of the input is determined (S1306). If the input indicates determination of the target graph, the flow is exited. If the input does not indicate the determination but indicates selection of a new element to be added to the target graph from the candidate graph, the selected element is added to the target graph (S1307), and the candidate time range is updated (S1308).

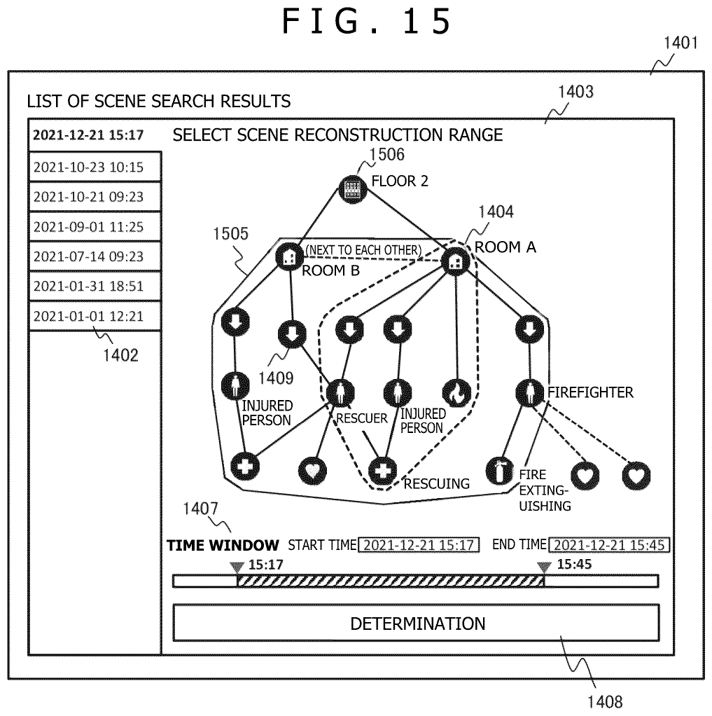

FIG. 14 indicates an example of display on the user interface unit 113 in the presentation processing to the user interface unit 113 at processing S1304 in the interactive scene expansion processing in FIG. 13. In FIG. 14, a plurality of tabs 1402 of candidate scenes matching a query graph are displayed on a screen 1401 of a list of scene search results. When any one of the candidate scenes is selected, a scene reconstruction range selection screen 1403 is displayed.

A partial graph of a scene reconstruction target/candidate is displayed on the scene reconstruction range selection screen 1403. A partial graph 1404 (area surrounded by a dotted line) matching the query graph, and a partial graph 1405 (area surrounded by a solid line) expanded on the basis of the partial graph 1404 matching the query graph at the automatic scene expansion step S1103 are indicated as partial graphs of a reconstruction target. That is, the expanded partial graph 1405 is a partial graph obtained by expansion within the same space range and the same time range. Furthermore, a candidate graph element 1406 added at the interactive scene expansion processing S1104 is displayed. Moreover, a time window 1407 which represents a candidate time range and a determination button 1408 for determining a scene are displayed.

The scene reconstruction range selection screen 1403 receives either one of an operation input for selecting one of the candidate graph elements 1406 and an operation input for depressing the determination button 1408.

That is, as a specific example, FIG. 14 indicates a firefighting and rescuing scene in a disaster. The query graph is a “rescue operation in a room including a fire point.” The expanded partial graph 1405 of the reconstruction target having undergone the automatic scene expansion is a “scene where a rescuer rescues an injured person, and, at the same time, a firefighter fights a fire in the fire point” in which the entirety of a scene having the same time range in the same space is made a reconstruction target on the basis of a range that matches the query. In addition, a candidate graph element 1406 that is spatially or temporarily close to the expanded partial graph 1405 of the current reconstruction target is presented as a candidate graph to the user.

FIG. 15 is an example of display updated after selection of one element 1409 from candidate graph elements 1406 in FIG. 14. FIG. 15 indicates that the selected element 1409 is added to the target graph, a partial graph 1505 (an area surrounded by a solid line) is updated, as a partial graph of a reconstruction target, so as to include the selected element 1409 as a result of the automatic scene expansion processing S1103 and the interactive scene expansion processing S1104, and a candidate graph 1506 and the time window 1407 which represents a target time range are updated.

That is, FIG. 15 indicates a specific example in which the automatically-expanded partial graph 1505 of a reconstruction target based on a user selection comprehensively expresses a “scene in which a rescuer who has completed a rescue operation in a next room B joins to rescue an injured person in a room A, and, at the same time, a firefighter fights a fire in a fire point.”

As described so far, in the present embodiment, a geometry, a record, and a context in a scene are separately recorded, and a scene reconstruction target range is operated on a knowledge graph in which the context is recorded. That is, a context is described in a knowledge graph while a geometry and a record are fragmented into node units in the graph, and are stored. A geometry and a record can be reconstructed by node units, if necessary. In addition, since a knowledge graph holds a time-series context of a scene, a search can be made while the context is taken into consideration.

Further, since a geometry and a record are fragmented into node units on a graph, a scene reconstruction target area can be operated on the graph. Moreover, scene expansion can be implemented while a spatial or temporal closeness/inclusion relationship described on a knowledge graph is taken into consideration. That is, in accordance with a rule, a scene is automatically expanded so as to satisfy consistency and comprehensiveness of the scene, an element that is spatially or temporally next or close is presented as a candidate, and interactive scene expansion for realizing a desired scene is performed in combination with the automatic expansion. In other words, a target range is automatically expanded and expansion candidates are presented in view of the spatial and temporal relationship recorded in a knowledge graph.

Accordingly, a scene reconstruction target range can be operated on a knowledge graph, so that a desired scene can be easily extracted and reconstructed on the basis of semantic information (e.g., an event and an action). In addition, spatial and temporal closeness/inclusion relationships recorded in a knowledge graph can be used to properly (comprehensively) extract a scene while interactions between objects are considered. That is, since only a part is extracted as a target range, a concern for generation of a misleading scene that does not properly describe interactions between people, objects, etc., can be dispelled.

Therefore, the present embodiment can provide a scene recording and reconstructing device and a scene recording and reconstructing method by which extraction and reconstruction of a desired scene can be easily implemented and proper extraction of a scene can be implemented.

An embodiment of the present invention has been explained so far. However, according to the present invention, a desired scene can be easily selected from among stored case examples and past actual cases, and can be recreated, experienced, and simulated. Accordingly, a scene focusing on a particular person or a particular action can be easily reconstructed, so that the efficiency of training, experiences, simulations, etc., is enhanced. Therefore, the present invention makes a contribution to achieving the SDGs (Sustainable Development Goals), or particularly, to achieving higher levels of economic productivity through technological upgrading and innovation in goal 8: “Decent work and economic growth.”

In addition, the present invention is not limited to the aforementioned embodiment, and encompasses a variety of modifications thereof. For example, the aforementioned embodiment is a detailed easy-to-understand illustration of the present invention, and thus, the present invention is not necessarily limited to an embodiment including all the features described above.

### REFERENCE SIGNS LIST

101: Scene recording and reconstructing device
102: Real space sensing device
103: Network
104: Sensor
105: Sensor data integration unit
106: Sensor data transmission unit
107: Sensor data reception unit
108: Scene registration unit
109: Record recording unit
110: Geometry recording unit
111: Knowledge graph recording unit
112: Scene reconstruction unit
113: User interface unit
201: Space layer
202: Stay event layer
203: Agent/object layer
204: Activity layer
205: District node
206: Building node
207: Floor node
208: Room node
209: Relation
210: Stay node
211: Agent node
212: Object node
213, 214: Action node
1401: Screen of list of scene search results
1402: Tab
1403: Scene reconstruction range selection screen
1404: Partial graph matching query graph
1405: Expanded partial graph
1406: Candidate graph element
1407: Time window
1408: Determination button
1505: Partial graph

1. A scene recording and reconstructing device that records and reconstructs scenes in a virtual space, the scene recording and reconstructing device comprising:
a geometry recording unit that records geometry information which describes a shape or an appearance of an object constituting a scene;
a record recording unit that records record information which is time-series information on an event performed by an object;
a knowledge graph recording unit that records a context of a scene as a knowledge graph; and
a scene reconstruction unit that reconstructs a desired scene in a virtual space, as required, by identifying a reconstruction target scene from a context of a scene recorded in the knowledge graph recording unit, acquiring geometry information and record information required to reconstruct the desired scene respectively from the geometry recording unit and the record recording unit, and re-combining the geometry information and the record information.

2. The scene recording and reconstructing device according to claim 1, wherein
the knowledge graph is formed of nodes each corresponding either to individual geometry information or to individual record information, and a link describing a relationship between the nodes, and
the scene reconstruction unit identifies a partial graph including a node corresponding to the geometry information, a node corresponding to the record information, and a link linking the nodes to each other, and reconstructs a desired scene in a virtual space by reading the geometry information and the record information respectively from the geometry recording unit and the record recording unit and combining the geometry information and the record information.

3. The scene recording and reconstructing device according to claim 2, wherein
the scene reconstruction unit expands the identified partial graph so as to include all objects and events having a same time range in a same space, and reconstructs a scene in a virtual space by using the expanded partial graph.

4. The scene recording and reconstructing device according to claim 2, wherein
the scene reconstruction unit presents, as expansion candidates, an object and an event that are spatially or temporarily next or close to the identified partial graph, to a user, and allows the user to interactively select a scene reconstruction range based on user's selection/deletion of a candidate.

5. A scene recording and reconstructing method for a scene recording and reconstructing device configured to record and reconstruct scenes in a virtual space, the scene recording and reconstructing method comprising:
recording geometry information which describes a shape or an appearance of an object constituting a scene;
recording record information which is time-series information on an event performed by an object;
recording a context of a scene as a knowledge graph; and
reconstructing a desired scene in a virtual space, as required, by identifying a reconstruction target scene from a recorded context of a scene, and by re-combining geometry information and record information necessary to reconstruct the desired scene.

6. The scene recording and reconstructing method according to claim 5, wherein
the knowledge graph is formed of nodes each corresponding either to individual geometry information or to individual record information, and a link describing a relationship between the nodes, and
a partial graph formed of a node corresponding to the geometry information, a node corresponding to the record information, and a link linking the nodes to each other, is identified, and the recorded geometry information and the recorded record information are combined, whereby a desired scene is reconstructed in a virtual space.

7. The scene recording and reconstructing method according to claim 6, wherein
the identified partial graph is expanded so as to include all objects and events having a same time range in a same space, and the expanded partial graph is used to reconstruct a scene in a virtual space.

8. The scene recording and reconstructing method according to claim 6, wherein
as expansion candidates, an object and an event that are spatially or temporarily next or close to the identified partial graph are presented to a user, and the user is allowed to interactively select a scene reconstruction range based on user's selection/deletion of a candidate.
